(19) United States
(12) Patent Application Publication
(10) Pub. No.: US 2019/0163082 A1
(43) Pub. Date: May 30, 2019

(54) WHITE LIQUID DEVELOPER AND PRODUCTION METHOD THEREFOR, AND PRINTED MATTER USING SAME

(71) Applicants: TOYO INK SC HOLDINGS CO., LTD., Tokyo (JP); TOYO INK CO., LTD., Tokyo (JP)

(72) Inventors: Toshihiro TETSUKA, Tokyo (JP); Yuji SONETA, Tokyo (JP); Kazumasa HATTORI, Tokyo (JP)

(73) Assignees: TOYO INK SC HOLDINGS CO., LTD., Tokyo (JP); TOYO INK CO., LTD., Tokyo (JP)

(21) Appl. No.: 16/321,038

(22) PCT Filed: Jun. 30, 2017
(86) PCT No.: PCT/JP2017/024183

§ 371 Date: Jan. 28, 2019

(30) Foreign Application Priority Data
Jul. 29, 2016 (JP) 2016-150125

(51) Int. Cl. G03G 9/12; G03G 9/13; G03G 9/125

(52) U.S. Cl. CPC G03G 9/122; G03G 9/125; G03G 9/132

(57) ABSTRACT

One embodiment of the present disclosure relates to a white liquid developer that contains at least white toner particles containing a titanium oxide (A) as a pigment and a binder resin (B), a basic polymeric dispersant (C), and a carrier liquid (D), wherein the titanium oxide (A) is a titanium oxide that has been surface-treated with alumina and an organic compound, and the binder resin (B) has a solubility parameter (SP value) of 10 to 13.

### TECHNICAL FIELD

Embodiments of the present invention relate to a white liquid developer and a production method therefor, and to printed matter using the same.

### BACKGROUND ART

Liquid developers are dispersions containing toner particles dispersed in an electrically insulating carrier liquid. Liquid developers enable better micronization of the toner particles than dry powder toners, and also do not suffer from problems caused by the scattering of toner particles inside the image formation device, and are therefore capable of forming high-definition images. Further, toner particles are formed with a colorant, a binder resin, and, where necessary, other optional additives such as a pigment dispersant, and in order to obtain printed matter having excellent image density, it is desirable that the colorant in the toner particles is dispersed uniformly and finely, and that the toner particles are charged in a stable manner.

On the other hand, white-colored liquid developers (white liquid developers), which are used for forming a white base on colored paper substrates or transparent film substrates, require sufficient opacity to prevent problems such as show-through of the color of the colored substrate or deterioration in the color development of the printed layer. In order to achieve favorable opacity, it is desirable that incident light irradiated onto a layer formed using the white liquid developer is scattered or reflected as much as possible.

In order to enhance the opacity of a white liquid developer or white toner particles, it is desirable to improve the dispersibility of the white colorant within the white toner particles. However, although titanium oxide, which is typically used as the white colorant, is an inorganic pigment, the binder resin that represents the main component of the toner particles is an organic material, and the two do not mix well in their unmodified states. In order to enable the titanium oxide to be dispersed uniformly and finely, some form of innovation is required. For example, Patent Literature 1 discloses a white dry toner containing, as the white pigment, a high-purity titanium oxide containing at least 99% by mass of titanium oxide, not more than 0.1% by mass of alumina, and not more than 0.05% by mass of silica. This represents an example in which the surface of the titanium oxide is treated with alumina and silica, but depending on the binder resin that is used with the white pigment, the dispersion of the titanium oxide may still be unsatisfactory, and for example in those cases where the toner is produced by the melt kneading method described below, the titanium oxide, which also functions as a conductive material, is easily exposed at the toner surface, resulting in a deterioration in the charging characteristics and the transferability of the toner particles. Further, Patent Literature 2 discloses an example that uses titanium oxide that has been surface-treated with an organic material in addition to silica and alumina. As expected, as the amount of the organic material used for treating the titanium oxide surface is increased, the dispersibility within the toner particles improves, but these surface treatments make it more difficult to maintain an electrostatic charge on the toner particles during printing, resulting in a deterioration in the transferability.

As outlined above, in a white toner that uses titanium oxide as the white colorant, achieving a combination of favorable opacity, namely dispersibility within the toner particles, and transferability during printing is a significant problem. Furthermore, particularly in those cases where the white toner particles are used as the toner particles that form a liquid developer, the dispersion stability of the white toner particles in the carrier liquid must also be taken into consideration. No white liquid developer currently exists that is able to address all of the above problems.

### CITATION LIST

### Patent Literature

PLT 1: JP H01-000574

PLT 2: European Patent Application No. 280378

### SUMMARY OF INVENTION

### Technical Problem

One embodiment of the present invention addresses the above problems, and has an object of providing a white liquid developer that exhibits excellent opacity, transferability, and dispersion stability within the carrier liquid. Other embodiments of the present invention have the objects of providing a method for producing the white liquid developer, and printed matter obtained using the white liquid developer.

### Solution to Problem

As a result of intensive research aimed at achieving the above objects, the inventors of the present invention discovered a combination of a specific titanium oxide and a specific binder resin, and they were therefore able to complete the present invention.

In other words, one embodiment of the present invention relates to a white liquid developer that includes at least white toner particles containing a titanium oxide (A) as a pigment and a binder resin (B), a basic polymeric dispersant (C), and a carrier liquid (D), wherein the titanium oxide (A) is a titanium oxide that has been surface-treated with alumina and an organic compound, and the binder resin (B) has a solubility parameter (SP value) of 10 to 13.

Further, according to one embodiment of the present invention, it is preferable that the acid value of the binder resin (B) is from 20 to 70 mgKOH/g.

Further, according to one embodiment of the present invention, it is preferable that the organic compound contains at least a siloxane compound.

Further, according to one embodiment of the present invention, it is preferable that the purity of the titanium oxide (A) is from 95 to 99% by mass.

Furthermore, one embodiment of the present invention relates to a method for producing any one of the white liquid developers described above, the method having a step of producing chips for white toner particles by melt kneading a mixture containing the titanium oxide (A) and the binder resin (B), and a step of mixing the chips for white toner particles with the basic polymeric dispersant (C) and the carrier liquid (D), and then performing wet grinding.

Furthermore, one embodiment of the present invention relates to a printed item having a recording medium, and a layer formed on the recording medium using any one of the white liquid developers described above.

Further, according to one embodiment of the present invention, it is preferable that the recording medium is at least one medium selected from among paper substrates and film substrates.

This application is related to the subject matter disclosed in prior Japanese Application 2016-150125 filed on Jul. 29, 2016, the entire contents of which are incorporated herein by reference.

### Advantageous Effects of Invention

Embodiments of the present invention are able to provide a white liquid developer that exhibits excellent opacity, transferability and dispersion stability within the carrier liquid, a method for producing the white liquid developer, and printed matter obtained using the white liquid developer.

### DESCRIPTION OF EMBODIMENTS

Preferred embodiments of the present invention are described below in detail. The present invention is in no way limited by the following embodiments, and also includes modifications that can be made without altering the scope of the present invention. Further, unless specifically stated otherwise, “parts” and “%” represent “parts by mass” and “% by mass” respectively.

### (White Liquid Developer)

As has already been described in the conventional technology, the titanium oxide is generally subjected to a surface treatment to improve the dispersibility of the titanium oxide within white toner particles and the opacity, but the surface treatment tends to cause a deterioration in the transferability, and because the amount of toner particles transferred to the substrate decreases, problems including a deterioration in the opacity and image irregularities tend to arise.

As a result of intensive research aimed at addressing the above problems, the inventors of the present invention discovered that the problems could be resolved by using a combination of a specific titanium oxide and a specific binder resin.

The white liquid developer according to one embodiment of the present invention contains at least white toner particles containing a titanium oxide (A) as a pigment and a binder resin (B), a basic polymeric dispersant (C), and a carrier liquid (D), wherein the titanium oxide (A) has been surface-treated with alumina and an organic compound, and the binder resin (B) has a characteristic solubility parameter (SP value).

The SP value is a scale that indicates the affinity between materials, and can be calculated using a method described below. Although detailed reasons remain unclear, it is thought that binder resins (B) for which the SP value is from 10 to 13 not only exhibit favorable compatibility with the titanium oxide (A), but also exhibit excellent affinity with the basic polymeric dispersant (C), thereby improving the adsorption of the basic polymeric dispersant (C), resulting in excellent dispersion stability of the white toner particles in the carrier liquid (D).

As described above, in order to obtain a white liquid developer having excellent opacity, transferability, and dispersion stability within the carrier liquid, a combination of the titanium oxide (A) having a specific surface treatment, the binder resin (B) having a specific solubility parameter, and the basic polymeric dispersant (C) is used. It should be noted that the above mechanism is merely a hypothesis, and in no way limits the present invention.

Each of the components used in the embodiments of the present invention are described below.

### (White Toner Particles)

The white toner particles (hereafter sometimes referred to as simply the “toner particles”) used in the white liquid developer contain at least the titanium oxide (A) as a pigment and the binder resin (B), and may also contain other additives such as a pigment dispersant and a release agent. Further, the basic polymeric dispersant (C) may also be added during production of the white toner particles.

### (Titanium Oxide (A))

The titanium oxide is treated with at least alumina and an organic compound. Further, an additional treatment with an oxide of an inorganic metal such as silicon, zirconium or titanium, or with an organometallic compound or the like may also be performed as an inorganic compound treatment. This optionally used organometallic compound is deemed to be not included within the scope of the “organic compound”. Among the various possibilities, titanium oxide that has been treated with zirconium oxide has a higher amount of base at the surface, and is preferred in terms of mixing well with binder resins having acid groups, thereby facilitating dispersion within the binder resin.

Furthermore, examples of the treatment with an organic compound include treatment with a siloxane compound, a polyhydric alcohol, an alkanolamine or derivative thereof, and a higher fatty acid or a metal salt or the like thereof, and of these, treatments that include a siloxane compound are preferred, and treatments with a compound that also has a carbon-silicon bond are more preferred. The “siloxane compound” used in the organic compound treatment is a siloxane compound that has an organic group.

In one embodiment, any of the crystal forms of titanium oxide including the anatase form, the rutile form and the brookite form may be used as the titanium oxide (A), but of these, the rutile form which has the highest refractive index is preferred. Further, the production method may use either of the conventionally known sulfuric acid method or the chlorine method, but in terms of suppressing the production of impurities and preventing any reduction in the charging characteristics of the toner particles, titanium oxide produced using the chlorine method is preferably selected.

According to one embodiment, the purity of the titanium oxide (A) is preferably at least 95% by mass but not more than 99% by mass. By ensuring the purity is at least 95% by mass, any deterioration in the charging characteristics and the transferability as a result of the surface treatment can be suppressed, and by ensuring the purity is not more than 99% by mass, favorable dispersibility of the titanium oxide (A) within the white toner particles can be achieved. Further, in terms of further improving the above characteristics, the purity of the titanium oxide (A) is particularly preferably at least 95% by mass but not more than 98% by mass. The purity of the titanium oxide (A) refers to the ratio of the mass of titanium oxide that is subjected to surface treatment relative to the total mass of the overall titanium oxide (A).

The total amount of the titanium oxide (A) contained within the toner particles varies depending on the type of binder resin (B) that is used, but typically, the amount is preferably from 10 to 70% by mass, and more preferably from 20 to 60% by mass, relative to 100 parts by mass of the toner particles.

Examples of suitable commercially available products of titanium oxide (A) that has been treated with alumina and an organic compound include TIPAQUE (a registered trademark) CR-57, 60-2, 63, SUPER 70, PC-3, PF-690, 691, 699, 728, 739, 740 and UT-771 (manufactured by Ishihara Sangyo Kaisha, Ltd.), Kronos (a registered trademark) 2064, 2190, 2230, 2233, 2300 and 2310 (manufactured by Kronos Worldwide, Inc.), Tipure (a registered trademark) PCx-01 (manufactured by DuPont Corporation), and TiONA (a registered trademark) 188 and RCL-69 (manufactured by Millennium Inorganic Chemicals Thann SAS). Among these, TIPAQUE CR-63 and PF-740, Kronos 2230 and 2233, and TiONA 188 and RCL-69 include a siloxane compound as an organic compound and also have a purity of at least 95% by mass but not more than 99% by mass, and can therefore be used particularly favorable as the titanium oxide (A).

Further, according to one embodiment, the titanium oxide (A) can be obtained by subjecting a titanium oxide that has been treated with either alumina or an organic compound, or a titanium oxide that has not undergone surface treatment, to treatment with the remaining components (namely, the alumina and/or the organic compound) using conventional materials and techniques. For example, the titanium oxide (A) can be obtained by subjecting a commercially available titanium oxide that has been treated only with alumina, such as TIPAQUE CR-50, 58 or 60, to a treatment with the organic compound.

### (Binder Resin (B))

Binder resins generally have a function of uniformly dispersing the colorant within the resin, and a function as a binder when the toner particles are fixed to a substrate such as paper. As described above, the binder resin (B) has a solubility parameter (SP value) of 10 to 13.

### (Solubility Parameter (SP Value))

The SP value of the binder resin (B) is within a range from 10 to 13, and is preferably within a range from 10 to 12. Ensuring that the SP value falls within this range improves not only the compatibility with the titanium oxide (A), but also the affinity with the basic polymeric dispersant (C), thereby favorably improving the dispersibility of the titanium oxide (A) and the dispersibility of the white toner particles. In this description, the SP value means the value determined using Fedors method based on formula (1) shown below, and has units of (cal/cm³)^{1/2}.

SP value=(ΣΔei/τΔvi)^{1/2} (1)

In formula (1) above, Δei represents the evaporation energy (cal/mol) of the atom or atom grouping, and Δvi represents the molar volume (cm³/mol). Δei and Δvi are described by R. F. Fedors in “Polymer Engineering & Science” (volume 14, issue 2, 1974, pp. 147 to 154).

### (Acid Value)

The acid value of the binder resin (B) is preferably within a range from 20 to 70 mgKOH/g. Provided the acid value falls within this range, the compatibility between the titanium oxide (A) and the binder resin (B) improves, and the dispersibility of the titanium oxide (A) can be further improved. Furthermore, in terms of improving the adsorption of the basic polymeric dispersant (C) to the binder resin (B), thereby improving the dispersion stability of the white toner particles, and from the viewpoint of improving the charging characteristics of the toner particles, thereby improving the opacity and color development of the toner particles, the acid value is more preferably from 20 to 55 mgKOH/g, and particularly preferably from 20 to 40 mgKOH/g. The acid value can be determined by dissolving 5 g of the binder resin (B) in 100 mL of a solvent obtained by mixing equal amounts (equal volumes) of methyl ethyl ketone and ethanol, subsequently using a potentiometric titration method to perform a titration at room temperature (25° C.) with a 0.1 mol/L aqueous solution of sodium hydroxide, and then calculating the acid value from the amount of the aqueous solution of sodium hydroxide used in reaching the titration end point. Specifically, the acid value can be measured using an automatic potentiometric titrator AT-610 manufactured by Kyoto Electronics Manufacturing Co., Ltd. The acid value is represented by the number of mg of potassium hydroxide (KOH) required to neutralize the acid contained within 1 g of the binder resin (B).

In one embodiment, in terms of making it easier to ensure that the aforementioned SP value and acid value fall within the respective preferred ranges, and also achieving excellent fixability of the toner particles to the recording medium, a polyester resin (b-1) is preferably included as the binder resin (B). A thermoplastic polyester is preferred as the polyester resin (b-1), and a resin obtained from a polycondensation of a dihydric or trihydric or higher alcohol component and a divalent or trivalent or higher carboxylic acid is the most desirable.

Examples of the above dihydric or trihydric or higher alcohol component include dihydric alcohols such as ethylene glycol, 1,2-propanediol, 1,3-propanediol, 1,3-butanediol, 1,4-butanediol, 2,3-butanediol, 1,4-butenediol, diethylene glycol, triethylene glycol, 1,5-pentanediol, 1,6-hexanediol, neopentyl glycol, 2-ethyl-1,3-hexanediol, bisphenol A, compounds in which an alkylene oxide has been added to bisphenol A, such as the bisphenol derivatives represented by general formula (2) shown below, hydrogenated bisphenol A, and 1,4-bis(hydroxymethyl)cyclohexane; and trihydric or higher alcohols such as glycerol, diglycerol, sorbitol, sorbitan, butanetriol, trimethylolethane, trimethylolpropane, pentaerythritol, dipentaerythritol and tripentaerythritol. These compound may be used individually, or a combination of two or more compounds may be used.

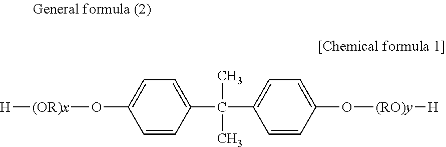

In the above general formula (2), R represents an ethylene group or a propylene group, each of x and y represents an integer of 1 or greater, and the average value of x+y is from 2 to 10.

Further, examples of the aforementioned divalent or trivalent or higher carboxylic acid include divalent carboxylic acids or anhydrides thereof, including benzenedicarboxylic acids or anhydrides thereof such as phthalic acid, terephthalic acid, isophthalic acid and phthalic anhydride; alkyldicarboxylic acids or anhydrides thereof such as succinic acid, adipic acid, sebacic acid and azelaic acid; succinic acids substituted with an alkyl group of 16 to 18 carbon atoms or anhydrides thereof; unsaturated dicarboxylic acids or anhydrides thereof such as fumaric acid, maleic acid, citraconic acid, itaconic acid and glutaconic acid; cyclohexanedicarboxylic acids or anhydrides thereof; naphthalenedicarboxylic acids or anhydrides thereof; diphenoxyethane-2,6-dicarboxylic acid or the anhydride thereof; and rosin derivatives such as acrylic-modified rosins; and trivalent or higher carboxylic acids or anhydrides thereof such as trimellitic acid, pyromellitic acid, naphthalenetricarboxylic acid, butanetricarboxylic acid, hexanetricarboxylic acid, tetra(methylenecarboxyl)methane, octanetetracarboxylic acid, benzophenonetetracarboxylic acid, or anhydrides of these acids.

These compound may be used individually, or a combination of two or more compounds may be used.

Examples of preferred compounds among the dihydric or trihydric or higher alcohol components listed above include compounds in which an alkylene oxide (preferably in an amount of 2 to 3 mol) has been added to bisphenol A, ethylene glycol and neopentyl glycol. Further, examples of preferred compounds among the divalent or trivalent or higher carboxylic acids listed above include dicarboxylic acids, including phthalic acid, terephthalic acid, isophthalic acid, and anhydrides of these acids; succinic acid, n-dodecylsuccinic acid, and anhydrides of these acids; and fumaric acid, maleic acid and maleic anhydride; and tricarboxylic acids such as trimellitic acid and the anhydride thereof.

In those cases where a polyester resin (b-1) is used, a resin synthesized using a conventional synthesis method such as a polycondensation method may be used, or a commercially available product may be used. In the case of a polycondensation, by adjusting the type of alcohol component and dicarboxylic acid that are reacted and the molar ratio between those components, as well as other factors such as the reaction temperature, the reaction time, the reaction pressure and the catalyst, the SP value and the acid value of the polyester resin (b-1) can be controlled. Further, in those cases where a commercially available product is used, by using a combination of two or more products and altering the blend ratio between those products, the SP value and the acid value of the polyester resin (b-1) can be controlled. Specific examples of commercially available polyester resins that can be used favorably include DIACRON ER-502 and DIACRON ER-508 (both manufactured by Mitsubishi Rayon Co., Ltd.).

In one embodiment, in terms of enabling an improvement in the grindability and the dispersion stability during production of the white toner particles, and in terms of having a low dielectric constant, thereby enhancing the charging characteristics and improving the opacity and the image quality, it is particularly desirable that the binder resin (B), in addition to the polyester resin (b-1) described above, also contains at least one type of resin (hereafter also referred to as the resin (b-2)) selected from the group consisting of styrene resins, (meth)acrylic resins and styrene-(meth)acrylic copolymer resins. The term “(meth)acrylic” means at least one type selected from among “acrylic” and “methacrylic”. Further, a “styrene-(meth)acrylic copolymer resin” means a resin obtained by copolymerizing at least one type of styrene-based monomer and at least one type of compound selected from among (meth)acrylic acid and (meth)acrylate esters.

Among the monomers that may be used in the resin (b-2), examples of compounds that can be used favorably as the styrene-based monomer include styrene, o-methylstyrene, m-methylstyrene, p-methylstyrene, α-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene and 3,4-dichlorostyrene. In terms of achieving superior compatibility with other constituent materials, styrene is particularly preferred.

Further, among the monomers that may be used in the resin (b-2), examples of (meth)acrylate esters that can be used favorably include methyl (meth)acrylate, ethyl (meth)acrylate, propyl (meth)acrylate, butyl (meth)acrylate, isobutyl (meth)acrylate, octyl (meth)acrylate, 2-ethylhexyl (meth)acrylate, lauryl (meth)acrylate, dodecyl (meth)acrylate, stearyl (meth)acrylate, 2-chloroethyl (meth)acrylate, phenyl (meth)acrylate, dimethylaminoethyl acrylate, and diethylaminoethyl (meth)acrylate. Among these, particularly preferred (meth)acrylate ester include butyl (meth)acrylate, octyl (meth)acrylate, and 2-ethylhexyl (meth)acrylate. The use of a (meth)acrylate ester that does not contain an amino group as the (meth)acrylate ester is preferred. In other words, the resin (b-2) preferably does not contain amino groups.

In addition, in order to increase the molecular weight of the resin (b-2), a polyfunctional monomer may be used as a crosslinking agent. Specifically, monomers such as divinylbenzene, diethylene glycol di(meth)acrylate, triethylene glycol di(meth)acrylate, 1,6-hexanediol di(meth)acrylate, neopentyl glycol di(meth)acrylate and trimethylolpropane tri(meth)acrylate may be used.

According to one embodiment, in those cases where the resin (b-2) is used as the binder resin (B), either a resin synthesized by a conventional synthesis method such as a suspension polymerization method, solution polymerization method or emulsion polymerization method may be used, or a commercially available product may be used. When the resin (b-2) is synthesized by a suspension polymerization method or the like, the molecular weight and the softening temperature and the like of the resin (b-2) can be controlled by adjusting the types of monomers used, the molar ratio between those monomers, the reaction temperature, the reaction time, the reaction pressure, the polymerization initiator, and/or the crosslinking agent or the like. Further, when commercially available products are used as the resin (b-2), by using a combination of two or more products, and adjusting the blend ratio between the products, the thermal properties and powder properties and the like of the toner particles can be controlled as desired. Specific examples of commercially available products that can be used favorably include ALMATEX CPR100, CPR200, CPR300 and CPR600B (manufactured by Mitsui Chemicals, Inc.).

Examples of the method used for mixing the polyester resin (b-1) and the resin (b-2) include a method in which the polyester resin (b-1) and the resin (b-2) are subjected to melt kneading; a method in which the polyester resin (b-1) and the resin (b-2) are each dissolved separately in a solvent, the two solutions are mixed, and the solvents are then removed; a method in which the monomers that form either the polyester resin (b-1) or the resin (b-2) are added to and polymerized in the presence of the other resin; and the methods disclosed in JP 3531980 B and JP 2006-178296 A. Of these, in terms of obtaining a more uniformly dispersed binder resin, the method in which the monomers that form either the polyester resin (b-1) or the resin (b-2) are added to and polymerized in the presence of the other resin is preferred. In particular, a method in which polycondensation of the polyester resin (b-1) is performed by bulk polymerization, the thus obtained polyester resin (b-1) is subsequently dissolved in a solvent, the monomers that form the resin (b-2) are then added to the solution, the resin (b-2) is then synthesized by solution polymerization, with heating performed as required, and the solvent is then removed, is preferred.

According to one embodiment, in those cases where a mixture of the polyester resin (b-1) and the resin (b-2) is used as the binder resin (B), the mass ratio between the polyester resin (b-1) and the resin (b-2) [(b-2)/(b-1)] is preferably not more than 1, and more preferably 0.5 or less. Ensuring that this mass ratio is not more than 1 improves the dispersibility of the titanium oxide (A), improves the color development and opacity, also improves the grindability of the toner particles, thereby making it easier to control the average particle size of the white toner particles, and improves the transferability and the storage stability of the liquid developer.

### (Average Molecular Weight)

In one embodiment, in terms of the offset resistance, the fixability, and the image quality characteristics, the binder resin (B) preferably has a weight average molecular weight (Mw) measured by gel permeation chromatography (GPC) of 4,000 to 100,000, more preferably 6,000 to 70,000, and particularly preferably 8,000 to 50,000. Provided the weight average molecular weight (Mw) of the binder resin (B) is at least 4,000, the hot offset resistance, the color reproducibility and the dispersion stability improve, whereas provided the weight average molecular weight is not more than 100,000, the fixability improves, and the color development and opacity also improve. The binder resin (B) may have either a molecular weight distribution curve with two or more peaks due to low-molecular weight components and high-molecular weight components, or a single-peak molecular weight distribution curve.

Further the ratio Mw/Mn between the weight average molecular weight (Mw) and the number average molecular weight (Mn) measured by GPC is preferably within a range from 2 to 18. Provided the value of Mw/Mn is 2 or exceeds 2, the offset resistance improves, the non-offset region expands, and low-temperature fixability improves. Provided the value of Mw/Mn is 18 or less than 18, the grindability of the toner particles improves, and the image characteristics also improve favorably, including satisfactory image density and improved color development.

The aforementioned molecular weight and molecular weight distribution determined by GPC can be measured using a Gel Permeation Chromatograph (HLC-8220) manufactured by Tosoh Corporation, under the following conditions. That is, the column is first stabilized inside a 40° C. heat chamber, tetrahydrofuran (THF) is passed through the column as a solvent at this temperature at a rate of 0.6 mL per minute, and 10 μL of a sample solution dissolved in THF is then injected into the column and measured. During measurement of the molecular weight of the sample, the molecular weight distribution of the sample is calculated from the relationship between the logarithmic value and the count value of a calibration curve prepared using a series of monodisperse polystyrene standard samples.

Ten polystyrenes manufactured by Tosoh Corporation and having molecular weights of about 10² to 10⁷ are used as the standard polystyrene samples for preparing the calibration curve. An RI (refractive index) detector is used for the detector. Three TSKgel Super HM-M columns (manufactured by Tosoh Corporation) are used for the column.

### (Other Materials Used in White Toner Particles)

According to one embodiment, a pigment dispersant, a release agent and/or a charge control agent or the like may be used in the white toner particles in addition to the titanium oxide (A) and the binder resin (B).

### (Pigment Dispersant)

Examples of pigment dispersants that can be included internally within the toner particles include polyamine-based resin dispersants such as Solsperse 24000SC and Solsperse 32000, 33000, 35000, 39000, 76400 and 76500 (manufactured by The Lubrizol Corporation), and AJISPER PB821 and 822 (manufactured by Ajinomoto Fine-Techno Co., Inc.); and acrylic copolymer resin dispersants such as BYK-116 (manufactured by BYK-Chemie GmbH). Particularly in those cases where production of the white toner particles is performed using a color masterbatch having a high pigment concentration, addition of a pigment dispersant during production of the masterbatch is preferred. In terms of improving the dispersibility of the toner particles, the amount added of the pigment dispersant is preferably at least 3 parts by mass, and more preferably 5 parts by mass or greater, per 100 parts by mass of the colorant. Further, in terms of improving the grindability and productivity of the toner particles, the amount of the pigment dispersant is preferably not more than 40 parts by mass, and more preferably 30 parts by mass or less, per 100 parts by mass of the colorant.

### (Release Agent)

Release agents generally generate a release effect by exuding to the coating film surface during fixation, or by forming an uneven surface. There are no particular limitations on the release agent, and conventional release agents may be used. Examples include hydrocarbon-based waxes (including polyolefin waxes such as polyethylene wax, polypropylene wax and polybutene wax, and long-chain hydrocarbon waxes such as paraffin wax, microcrystalline wax and Sasol wax) and derivatives thereof, polyester waxes and derivatives thereof, and polyamide waxes and derivatives thereof. Among the above waxes, in terms of achieving superior offset resistance and fixability, the use of a hydrocarbon-based wax is preferred, and among such hydrocarbon-based waxes, the use of a polyolefin wax is particularly desirable. Although the reasons are not entirely clear, it is thought that when a polyolefin wax is used, the adsorption of the basic polymeric compound (C) described below improves, thus enabling a white liquid developer of excellent storage stability to be obtained. The materials described above may be used individually, or a combination of two or more materials may be used.

In those cases where a commercially available product is used as the release agent, examples of polyolefin waxes that can be used favorably include Polywax 500, 1000 and 2080P (manufactured by TOYO ADL Corporation), Sanwax 131P and Sanwax 161P (manufactured by Sanyo Chemical Industries Ltd.), and HI-WAX 800P, HI-WAX 720P, HI-WAX 400P, HI-WAX 320MP, HI-WAX NP055 and HI-WAX NP105 (manufactured by Mitsui Chemicals, Inc.).

In one embodiment, the melting point of the release agent is preferably from 50 to 160° C., more preferably from 60 to 140° C., and even more preferably from 80 to 130° C. Provided the melting point is at least 50° C., the heat-resistant storage properties are favorable, whereas provided the melting point is not more than 160° C., cold offset can be suppressed during fixation at low temperature, both of which are desirable.

According to one embodiment, when a release agent is used, the amount of the release agent, relative to the total mass of the white toner particles, is preferably within a range from 1 to 40% by mass, more preferably from 2 to 30% by mass, and even more preferably from 3 to 10% by mass. By ensuring that the amount of the release agent falls within the above range, the offset resistance and the fixability of the liquid developer can both be kept within favorable ranges.

### (Charge Control Agent)

If necessary, the white toner particles may include a colorless or light-colored conventional charge control agent, provided there is no adverse effect on the color tone. The charge control agent may be either a positive charge control agent or a negative charge control agent depending on the polarity of the electrostatically charged image on the electrostatic latent image support that is to be developed. In one embodiment, the toner particles in the liquid developer preferably adopt a positive charge, and therefore a positive charge control agent is typically used.

Examples of positive charge control agents include quaternary ammonium salt compounds, organotin oxides, diorganotin borates, and electron donor substances such as amino group-containing polymers, and these positive charge control agents may be used individually, or a combination of two or more charge control agents may be used. Further, triarylmethane-based colorants can also be used as positive charge control agents in a similar manner. Moreover, instead of using an aforementioned charge control agent, a resin-based charge control agent may also be used. Examples of resin-based charge control agents include copolymers of acryloylamino-2-methyl-1-propanesulfonic acid and a vinyl-based monomer such as styrene or an acrylate ester. Typically, the resin-based charge control agent is preferably added in an amount of 1.0 to 20 parts by mass, and more preferably 2.0 to 8 parts by mass, per 100 parts by mass of the binder resin (B).

### (Other Colorants)

According to one embodiment, the white toner particles may also include another white colorant besides the titanium oxide (A) for the purpose of adjusting the color development and whiteness properties. Specific examples of this other colorant include inorganic compounds such as titanium oxide that is surface treated in the different manner from that of the titanium oxide (A), basic lead carbonate, zinc oxide and strontium titanate, and organic compounds such as hollow resin microparticles. In order to ensure a favorable effect from the titanium oxide (A), in those cases where another colorant is used, the blend amount of the other colorant is preferably less than the blend amount of the titanium oxide (A).

Furthermore, in order to adjust the color tone of the white toner particles, a colorant that is not white may also be used in combination with the white colorant. Examples of colorants that may be used as this non-white colorant include conventional organic colorants (organic pigments and organic dyes) and inorganic colorants (inorganic pigments and inorganic dyes), and for example, by using a small amount of a blue and/or violet colorant in combination with the titanium oxide (A), printed matter having a blue-tinged white color can be obtained.

### (Colorant Derivative)

In order to adjust the color tone of the white toner particles and also further improve the dispersibility of the titanium oxide (A), a colorant derivative may be used, provided the color development and whiteness properties of the titanium oxide (A) are not impaired. Specific examples of the colorant derivative include compounds in which a basic substituent, an acidic substituent, or a phthalimidomethyl group that may have a substituent has been introduced into an organic colorant, anthraquinone, acridone or triazine.

According to one embodiment, the dielectric constant of the white toner particles that form the white liquid developer is preferably at least 2 but not more than 6, and more preferably at least 3 but not more than 5. Provided the dielectric constant of the white toner particles is at least 2, a positive charge can be imparted easily to the white toner particles, whereas provided the dielectric constant is not more than 6, the applied positive charge can be more easily maintained, and favorable transferability can be achieved. The dielectric constant can be measured using white toner particles that have been placed in a humidity-controlled environment at 25° C. and 50% RH for 24 hours, by molding the toner particles into a plate-like form under a pressure of 200 kg/cm², setting the compressed plate between a pair of electrodes (manufactured by Ando Electrical Co., Ltd.), and using an LCR meter (manufactured by Yokogawa-Hewlett-Packard Co., Ltd.) to measure the dielectric constant under conditions including a voltage of 5 V and a frequency of 100 KHz.

### (Basic Polymeric Dispersant (C))

Generally, a dispersant is a substance that is added to the carrier liquid containing the toner particles, and has the effects of uniformly dispersing the toner particles and improving the developing characteristics. The basic polymeric dispersant (C) may be either added to the carrier liquid, or added during production of the white toner particles. When added to the carrier liquid to disperse the toner particles, it is surmised that the basic polymeric dispersant (C) adsorbs to binder resin portions on the surfaces of the toner particles, and particularly to polyester resin portions which exhibit an excellent dispersion-stabilizing effect.

There are no particular limitations on the basic polymeric dispersant (C), and any conventional material that is capable of stably dispersing the toner may be used. Furthermore, either a compound synthesized using a conventional synthesis method or a commercially available product may be used. Examples of commercially available products include Antaron V-216 and Antaron V-220 (both product names, manufactured by GAF/ISP Chemicals, Inc.) and Solsperse 13940 and Lubrizol 2153 (both product names, manufactured by The Lubrizol Corporation). Moreover, the polyamine-based resin dispersants described above for use as pigment dispersants can also be used favorably as the basic polymeric dispersant (C).

According to one embodiment, in a case where the basic polymeric dispersant (C) is synthesized using a conventional synthesis method, the basic polymeric dispersant (C) is preferably a (meth)acrylic copolymer resin having amino groups and alkyl groups of 9 to 24 carbon atoms. By having such a structure, the dispersion stability improves, and the transferability during multi-color printing, the opacity, and the storage stability can all be improved.

The (meth)acrylic copolymer resin having amino groups and alkyl groups of 9 to 24 carbon atoms can be produced favorably by a solution polymerization using materials including an ethylenic unsaturated monomer (c-1) having an amino group, an ethylenic unsaturated monomer (c-2) having an alkyl group of 9 to 24 carbon atoms, a polymerization initiator, and a chain transfer agent and the like.

In the (meth)acrylic copolymer resin having amino groups and alkyl groups of 9 to 24 carbon atoms, the proportion of the ethylenic unsaturated monomer (c-1) having an amino group is preferably from 1 to 50% by mass, more preferably from 5 to 40% by mass, and most preferably from 10 to 35% by mass. Further, in the copolymer resin, the proportion of the ethylenic unsaturated monomer (c-2) having an alkyl group of 9 to 24 carbon atoms is preferably from 50 to 99% by mass, more preferably from 60 to 95% by mass, and most preferably from 65 to 90% by mass.

In terms of the compositional ratio (molar ratio between the amounts added) between the ethylenic unsaturated monomer (c-1) having an amino group and the ethylenic unsaturated monomer (c-2) having an alkyl group of 9 to 24 carbon atoms, from the viewpoints of the adsorption to the binder resin (B) and the compatibility with the carrier liquid (D) that acts as an insulating solvent, the ratio of the ethylenic unsaturated monomer (c-1) having an amino group and the ethylenic unsaturated monomer (c-2) having an alkyl group of 9 to 24 carbon atoms is preferably within a range from 1:1 to 1:3, and is particularly preferably from 1:1.5 to 1:2.5.

The ethylenic unsaturated monomer (c-1) having an amino group is a component that can function as an adsorption group of the basic polymeric dispersant (C) relative to the white toner particles, and even in those cases where a titanium oxide having a higher specific gravity than the colorants of color toners is used, is capable of producing favorable dispersion stability and ensuring stable transferability and opacity over long periods of time. Although there are no particular limitations on the amino group, a secondary amino group or tertiary amino group is preferred, and a tertiary amino group is particularly preferred. The amino group mentioned above does not include amino groups that form an amide linkage. Examples of preferred compounds for the ethylenic unsaturated monomer (c-1) having an amino group include N,N-dimethylaminoethyl (meth)acrylate, N,N-diethylaminoethyl (meth)acrylate, and N,N-diethylaminopropyl (meth)acrylate. A combination of two or more ethylenic unsaturated monomers (c-1) having an amino group may also be used.

The ethylenic unsaturated monomer (c-2) having an alkyl group of 9 to 24 carbon atoms enhances the solubility in the carrier liquid (D) due to the alkyl group of 9 to 24 carbon atoms, and in the case of storage for a long period, suppresses aggregation and precipitation of the white toner particles and also suppresses any increase in the viscosity of the liquid developer, thereby improving the storage stability of the white liquid developer. Provided the number of carbon atoms in the alkyl chain is at least 9, the solubility of the ethylenic unsaturated monomer (c-2) in the carrier liquid (D) is high, and the dispersion stability and storage stability can be improved. Provided the number of carbon atoms in the alkyl group is not more than 24, the alkyl groups do not impede contact and coalescence of the toner particles when the liquid developer is fixed to the substrate, meaning no deterioration in the fixability occurs. Moreover, the charging characteristics of the toner particles improve, the toner particles can be transferred more easily to the substrate, and satisfactory opacity can be achieved.

Furthermore, the alkyl group of 9 to 24 carbon atoms may be a linear alkyl group, a branched alkyl group or a cyclic alkyl group, but is preferably a linear alkyl group or branched alkyl group, and is particularly preferably a linear alkyl group.

Examples of compounds that may be used as the ethylenic unsaturated monomer (c-2) having an alkyl group of 9 to 24 carbon atoms include conventional materials such as alkyl (meth)acrylates having an alkyl group of 9 to 24 carbon atoms, alkyl (meth)acrylamides having an alkyl group of 9 to 24 carbon atoms, (meth)acrylates and (meth)acrylamides containing an aromatic ring and an alkyl group of 9 to 24 carbon atoms, and α-olefins containing an alkyl group of 9 to 24 carbon atoms. From the viewpoint of dispersibility, a (meth)acrylate such as an alkyl (meth)acrylate having an alkyl group of 9 to 24 carbon atoms is preferred. A combination of two or more ethylenic unsaturated monomers having an alkyl group of 9 to 24 carbon atoms may also be used.

According to one embodiment, regardless of whether a synthesized compound or a commercially available product is used, the basic polymeric dispersant (C) preferably has an amine value from 5 to 150 mgKOH/g, and more preferably from 30 to 100 mgKOH/g. When the amine value is at least 5 mgKOH/g, the adsorption to the white toner particles is favorable, and the storage stability improves. Further, provided the amine value is not more than 150 mgKOH/g, the charging characteristics of the toner particles improve, thereby facilitating transfer of the toner particles to the substrate, and enabling more favorable opacity to be obtained. The amine value of the basic polymeric dispersant (C) indicates the total amine value (mgKOH/g) measured in accordance with the method prescribed in ASTM D2074.

The weight average molecular weight (Mw) of the basic polymeric dispersant (C) is preferably from 500 to 40,000, and more preferably from 2,000 to 30,000. Provided the molecular weight is at least 500, any increase in the viscosity of the white liquid developer can be suppressed, and the opacity improves favorably, whereas provided the molecular weight is not more than 40,000, the dispersion stability and charging characteristics of the toner particles improve, making it easier to achieve favorable transferability. The Mw of the basic polymeric dispersant (C) can be measured using the same method as that described for the Mw of the binder resin (B).

The basic polymeric dispersant (C) is preferably added in an amount within a range from 0.5 to 100 parts by mass, and more preferably 1 to 50 parts by mass, per 100 parts by mass of the white toner particles. Provided this amount is at least 0.5 parts by mass, the dispersibility and grindability of the toner particles improve, and the opacity increases. Provided the amount added is not more than 100 parts by mass, favorable charging characteristics for the toner particles can be more easily obtained and the transfer efficiency improves, meaning more favorable opacity and transferability can be achieved, and the film formability of the toner particles also improves, meaning the fixability also improves favorably.

### (Carrier Liquid (D))

The carrier liquid (D) used in the liquid developer is preferably an aliphatic hydrocarbon. Aliphatic hydrocarbons have lipophilicity and tend to have chemically stable insulating properties, meaning a white liquid developer having favorable storage stability and dispersibility can be obtained. Examples of the aliphatic hydrocarbon include linear paraffin-based hydrocarbons, isoparaffin-based hydrocarbons and naphthene-based hydrocarbons. Among these, paraffin-based hydrocarbons in which the amount of residual aromatic hydrocarbons is extremely small are preferred. Furthermore, the carrier liquid (D) is preferably chemically inert relative to the substances and devices used in the image forming apparatus, and particularly the members used in the developing process such as the photoreceptor and the surrounding members.

The dry point in the distillation range of the carrier liquid (D) is preferably within a range from 180 to 360° C., and more preferably within a range from 200 to 280° C. Provided the dry point is at least 180° C., the liquid developer does not dry on the roller of the photoreceptor or the like during the printing process, meaning favorable transferability can be maintained and superior opacity can be achieved. Further, provided the dry point is not higher than 360° C., removal of the carrier liquid (D) is easy, meaning favorable fixability can be obtained, and moreover, the viscosity of the liquid developer can be kept low and the mobility of the toner particles during developing is favorable, meaning the liquid developer is suitable for high-speed developing. The dry point in the distillation range indicates a value measured using the method prescribed in JIS K2254.

Further, the Kauri-butanol value (KB value: ASTM D1133) for the carrier liquid (D) is preferably not more than 30, and more preferably within a range from 20 to 30. Further, an aniline point (JIS K2256) within a range from 60 to 105° C., and preferably from 70 to 95° C. is preferred in terms of obtaining a more stable carrier liquid. Provided the Kauri-butanol value is not more than 30, or the aniline point is at least 60° C., the dissolution power of the carrier liquid as a solvent is low, and the carrier liquid does not dissolve the toner particles, and therefore the storage stability and the transferability of the toner particles improve. Further, the problem of coloration of the carrier liquid, which can cause staining of the substrate such as the paper, can be prevented. Provided the aniline point is not higher than 105° C., good compatibility is achieved with the dispersant and additives and the like added during dispersion of the toner particles in the carrier liquid, the dispersibility improves, and favorable opacity can be obtained.

In terms of the insulating properties of the carrier liquid (D), the dielectric constant is typically not more than 5, preferably from 1 to 5, and more preferably from 2 to 3. Further, the electrical resistivity of the carrier liquid (D) is preferably at least 10⁹ Ω·cm, more preferably 10¹⁰ Ω·cm or greater, and particularly preferably within a range from 10¹¹ to 10¹⁶ Ω·cm. The electrical resistivity can be measured using a combination of a Universal Electrometer MMA-II-17D and an electrode for liquids LP-05 manufactured by Kawaguchi Electric Works Co., Ltd. In those cases where the electrical resistivity is at least 10⁹ Ω·cm, the charging characteristics of the toner particles improve, favorable transferability is obtained, and the opacity improves.

Specific examples of preferred carrier liquids (D) include branched paraffin solvent mixtures such as the products Shellsol (a registered trademark) TM (manufactured by Shell Chemicals LP), IP Solvent (a registered trademark) 2028 (manufactured by Idemitsu Kosan Co., Ltd.), and Isopar (a registered trademark) M and L (manufactured by Exxon Mobil Corporation); and naphthene-based hydrocarbons such as Exxsol (a registered trademark) D40, D80, D110 and D130 (manufactured by Exxon Mobil Corporation), and AF Solvent No. 4 and No. 5 (manufactured by JXTG Nippon Oil & Energy Corporation). A single carrier liquid (D) may be used alone, or a combination of two or more liquids may be used. In particular, combining two or more carrier liquids having different volatilities is useful in obtaining both the carrier liquid property of excellent volatility, meaning the carrier liquid does not remain as a stain on the substrate during printing, and the carrier liquid property of resistance to volatilization within the printing apparatus, meaning stable printing can be performed.

The blend amount of the carrier liquid (D) is preferably from 60 to 90% by mass relative to 100% by mass of the total liquid developer. Provided this amount is at least 60% by mass, favorable fluidity can be obtained for the liquid developer, whereas provided the amount is not more than 90% by mass, favorable fixability and opacity can be obtained.

### (Production Method)

According to one embodiment, the method for producing the liquid developer may use a conventionally known method, and a conventionally used method such as the melt kneading method, suspension polymerization method or emulsion polymerization method may be selected as desired, but in terms of imparting force under high viscosity conditions, thereby achieving superior uniform dispersibility, and in terms of reducing the environmental load, the melt kneading method is preferably selected. In particular, in the case of the melt kneading method, the titanium oxide (A) can be dispersed finely and uniformly within the white toner particles even without applying excessive energy. Further, during dry grinding of the toner particles following melt kneading, the titanium oxide (A) is not ground at the grinding interface, with the degree of exposure of the titanium oxide (A) at the surfaces of the white toner particles being small, and as a result, discharge via the titanium oxide (A) can be prevented, meaning a white liquid developer having excellent charging characteristics can be obtained. In other words, according to one embodiment, it can be stated that the melt kneading method is particularly suitable as the method for producing the white liquid developer.

In one embodiment, the production method by melt kneading includes a step of melt kneading a mixture of the titanium oxide (A) and the binder resin (B) to prepare chips for the white toner particles, and a step of mixing the chips for the white toner particles with the basic polymeric dispersant (C) and the carrier liquid (D), and performing wet grinding.

A production example using the melt kneading method is described below as a preferred method for producing the liquid developer.

### (1) Preparation of Color Masterbatch for Toner Particles

The titanium oxide (A) and the binder resin (B) are kneaded using a twin-screw extruder or hot rollers or the like in a ratio that yields a concentration of the titanium oxide (A) in the masterbatch of 10 to 60 parts by mass, and following cooling, coarse grinding is performed to obtain a color masterbatch. Further, in addition to the titanium oxide (A) and the binder resin (B), a pigment dispersant, a charge control agent, other colorants, and/or a colorant derivative or the like may also be added.

### (2) Preparation of Chips for Toner Particles (Dilution of Color Masterbatch)

The color masterbatch obtained in step (1) and the binder resin (B) are mixed and preliminarily dispersed using a Super Mixer or the like, and melt kneading is then performed to dilute and disperse the masterbatch within the binder resin (B), thus obtaining chips for the toner particles. A pigment dispersant, the basic polymeric dispersant (C), a charge control agent, and/or a wax or the like may also be added during this preliminary dispersion step and melt kneading. The chips for the toner particles are preferably coarsely ground to a particle size of 5 mm or smaller using a hammer mill or a sample mill or the like. The steps (1) and (2) may be combined, and in such a case, the masterbatch preparation of step (1) is not performed, and all of the materials are simply combined during the preliminary dispersion in step (2) to prepare the chips for the toner particles. A conventional kneading device such as a pressurized kneader, a Banbury mixer, or a single-screw or twin-screw extruder may be used as the melt kneading device.

### (3) Dry Grinding of Toner Particles

The chips for the toner particles obtained in step (2) are finely ground to achieve an average particle size of 100 μm or less. Typically, the fine grinding is preferably performed using a jet stream grinder such as a jet mill or a mechanical grinder such as a turbo mill, Kryptron or hammer mill.

### (4) Wet Grinding of Toner Particles

The dry-ground toner particles obtained in step (3) are dispersed in a solvent having the same composition as the carrier liquid (D), and a wet grinder (dispersion device) is used to perform grinding of the toner particles to obtain an average particle size within a range from 0.5 to 4 μm, and preferably from 1 to 3 μm. At this time, addition of the basic polymeric dispersant (C) that has the function of adsorbing to the toner particles is also effective. Cooling is preferably performed so that the temperature of the mixture during grinding does not exceed 50° C. Provided the temperature is not more than 50° C., melting of the toner particles does not occur, meaning the particle size distribution can be controlled.

Examples of wet grinders that can be used for performing wet grinding of the toner particles include devices that use a grinding medium, such as container-driven medium mills and medium stirring mills, and of these, the use of a medium stirring mill is preferred in terms of the productivity, the grinding performance, and control of the particle size distribution and the like. Moreover, using a wet grinder that is classified as a horizontal distribution tank mill is preferred, and one specific example is the Dyno-Mill manufactured by Shinmaru Enterprises Corporation.

In the wet grinder, examples of factors which influence the grinding properties include the type of grinding media used, the particle size of the grinding media, the fill rate of the dispersion media inside the grinder, and the solution concentration, viscosity and solvent of the sample being ground, and among these, the type of grinding media used, and the particle size of the grinding media contribute significantly to the grindability.

The type of grinding media used may be selected in accordance with factors such as the viscosity and specific gravity of the toner particles, and the particle size desired following grinding and dispersion, and examples of grinding media that can be used include glass beads, zircon beads, zirconia beads, alumina, and titania and the like, but in terms of achieving more favorable grinding properties, the use of zirconia beads or zircon beads is preferable. Further, grinding media having a diameter within a range from 0.1 to 3.0 mm can be used, and a diameter within a range from 0.3 to 1.4 mm is preferred. Provided the diameter is 0.1 mm or larger than 0.1 mm, the load inside the grinder is reduced, and a deterioration in the grinding properties due to melting of the toner particles as a result of heat generation can be suppressed. Provided the diameter is 3.0 mm or less than 3.0 mm, satisfactory grinding can be performed.

### (5) Preparation of Liquid Developer

The carrier liquid (D), and if necessary the basic polymeric dispersant (C), are added to and mixed with the material obtained in step (4) containing the white toner particles, the optionally added basic polymeric dispersant (C) and the carrier liquid (D), and the concentration of the toner particles is adjusted.

### (Physical Properties of White Liquid Developer)

The volume average particle size (D50) of the white toner particles is preferably from 0.5 to 4 μm, and more preferably from 1 to 3 μm. The particle size can be measured using a laser diffraction and scattering particle size analyzer Microtrac HRA manufactured by Nikkiso Co., Ltd., and the D50 value represents the volume average particle size at 50% in the cumulative distribution. The carrier liquid (D) may be used as the measurement solvent.

Further, in terms of the developing properties required for obtaining favorable color development, it is preferable that the proportion of white toner particles having a particle size of 1 to 3 μm is from 5 to 60% by volume, and that the proportion of white toner particles having a particle size of 5 μm or greater is not more than 35% by volume. Provided the proportion of white toner particles having a particle size of 1 to 3 μm is from 5 to 60% by volume, favorable dispersion stability and excellent storage stability over long periods can be obtained for the white toner particles. Provided the proportion of toner particles having a particle size of 5 μm or greater is less than 35% by volume, satisfactory image density is obtained, and an opacity improvement effect is obtained, both of which are desirable.

The concentration of white toner particles in the liquid developer is preferably from 10 to 40% by mass, and more preferably from 12 to 35% by mass, relative to 100% by mass of the total liquid developer. By ensuring that the concentration is at least 10% by mass, removal of the carrier liquid (D) is easy, and the film formability of the white toner particles improves, thus improving the opacity. Further, by ensuring that the concentration is not more than 40% by mass, the viscosity of the liquid developer is lowered, the mobility of the white toner particles improves, and satisfactory transferability can be obtained. Moreover, aggregation of the white toner particles can be suppressed, thus improving the storage stability.

Furthermore, the electrical resistivity of the liquid developer is preferably from 10¹⁰ to 10¹⁵ Ω·cm. Provided the electrical resistivity is at least 10¹⁰ Ω·cm, maintaining the electrostatic charged image on the electrostatic latent image support is easier. Further, the charging characteristics also improve, and the transferability improves. The electrical resistivity can be measured using the same measurement method as that described above for the carrier liquid.

### (Liquid Developer Set)

The white liquid developer of the embodiment described above may be used in the form of a liquid developer set in combination with another color liquid developer. When used as a liquid developer set, examples of the printing method include a method in which initially only the white liquid developer is transferred and fixed to the printing substrate to form a solid printed surface, and the color liquid developer is then used to print an image onto the solid printed surface; a method in which initially only the color liquid developer is transferred and fixed to the printing substrate to form a printed image, and the white liquid developer is then used to perform solid printing to the surface of the printed image; and a method in which the white liquid developer and the color liquid developer are transferred either simultaneously or sequentially to the printing substrate, and fixation is then performed for all the colors to form an image, and any of these methods may be used favorably. Further, in those cases where the white liquid developer and the color liquid developer are transferred either simultaneously or sequentially to the printing substrate, the color order in which printing is performed may be selected as appropriate, but for example, by first transferring the white liquid developer to the printing substrate, the white liquid developer can also be used as a pretreatment liquid for the color liquid developer.

In the liquid developer set, provided the color liquid developer that is used in combination with the white liquid developer is colored, any appropriate developer may be used regardless of the hue or the composition of the liquid developer. Of the various possibilities, in those cases where a printing method is used in which the white liquid developer and the color liquid developer are transferred either simultaneously or sequentially to the printing substrate, the printing speed and fixing conditions for the color liquid developer will be the same as those of the white liquid developer, and therefore the materials that form the color liquid developer are preferably similar to the materials of the white liquid developer.

### (Printed Matter)

According to one embodiment, printed matter has a layer formed from the white liquid developer on a recording medium. The recording medium, namely the printing substrate, is preferably at least one substrate selected from the group consisting of paper substrates and film substrates.

### (Printing Substrate)

Although there are no particular limitations on the printing substrate onto which printing is performed using the liquid developer, paper substrates and film substrates are preferred, and a substrate selected from among high-quality papers, coated papers, PET sheets, and PP sheets is particularly preferred. Further, as described above in relation to the conventional technology, use of the liquid developer on a colored or transparent printing substrate is particularly desirable, as it enables the opacity that represents one of the effects of the white liquid developer to be effectively employed. The surface of the printing substrate may be either smooth or rough, and there are no limitations on the thickness or shape of the printing substrate. Moreover, substrates in which two or more types of these printing substrates have been bonded together may also be used, and a releasable adhesive layer or the like may be provided on the opposite side to the printing surface, or an adhesive layer or the like may be provided on the printed surface following printing.

### (Applications of Printed Matter)

There are no particular limitations on the printed matter that is printed using the liquid developer, and the printed matter can be used for typical commercial applications, paper packaging, packaging films, seals, or label applications or the like. Examples of the typical commercial applications include publications or documents such as catalogs or magazines which use high-quality paper or coated paper or the like, examples of the paper packaging include packaging containers and boxes which use coated paper or cardboard or the like, whereas examples of the packaging films include flexible packaging containers which use a PET sheet or PP sheet or the like.

### EXAMPLES

The present invention is described below in further detail using a series of examples, but the aspects of the present invention are not limited by these examples. Unless specifically stated otherwise, “parts” and “%” indicate “parts by mass” and “% by mass” respectively.

### (Titanium Oxide)

Using the titanium oxides shown below in Table 1, the liquid developers described below were produced. The surface treatment, purity, primary particle size, production method and crystal form of each of the titanium oxides are also shown in Table 1.

TABLE 1

| | | Surface treatment | | Purity | Primary | | |
|---|---|---|---|---|---|---|---|
| | | Inorganic | Organic | (% by | particle size | Production | Crystal |
| Product name | Manufacturer | compounds | compounds | mass) | (μm) | method | form |
| TIPAQUE PF671 | Ishihara Sangyo | alumina, silica | polyol | 97 | 0.21 | Chlorine | rutile |
| TIPAQUE PF690 | Kaisha, Ltd. | alumina, silica | polyol | 93 | 0.21 | method | |
| TIPAQUE PF691 | | alumina, silica | siloxane, polyol | 94 | 0.21 | | |
| TIPAQUE PF739 | | alumina, zirconia | polyol | 97 | 0.25 | | |
| TIPAQUE PF740 | | alumina, zirconia | siloxane | 96 | 0.25 | | |
| TIPAQUE CR-50 | | alumina | | 95 | 0.25 | | |
| TIPAQUE CR-58 | | alumina | | 93 | 0.28 | | |
| TIPAQUE CR-63 | | alumina, silica | siloxane, polyol | 97 | 0.21 | | |
| TIPAQUE CR-80 | | alumina, silica | | 93 | 0.25 | | |
| TIPAQUE CR-97 | | alumina, zirconia | | 93 | 0.25 | | |
| KRONOS 2230 | Kronos Worldwide, Inc. | alumina, silica | siloxane | 96 | 0.20 | | |
| TIPAQUE R-930 | Ishihara Sangyo | alumina, silica | | 93 | 0.25 | Sulfuric acid | rutile |
| TIPAQUE A-220 | Kaisha, Ltd. | alumina | | 96 | 0.15 | method | anatase |

### (Production Example for Surface-Treated Titanium Oxide 1)

A Henschel mixer (capacity: 20 L) was charged with 100 parts of TIPAQUE PF739 (manufactured by Ishihara Sangyo Kaisha, Ltd.), and by subsequently adding 0.5 parts of a silicone oil KF-96L-1cs (manufactured by Shin-Etsu Silicone Co., Ltd.) containing polydimethylsiloxane and performing mixing (3,000 rpm, 3 minutes), a surface-treated titanium oxide 1 that was a siloxane-treated product of PF739 was obtained. The purity of the surface-treated titanium oxide 1 was 96.5% by mass.

### (Production Examples for Surface-Treated Titanium Oxides 2 to 7)

With the exception of altering the titanium oxide used to the titanium oxide shown below in Table 2, the same method as that used for producing the surface-treated titanium oxide 1 was used to obtain surface-treated titanium oxides 2 to 7, each of which was a siloxane-treated product.

TABLE 2

| | | | | Purity |
|---|---|---|---|---|
| | | | | following |
| | | | | surface |
| | | Silicone oil | | treatment |
| | Titanium oxide | Product | Amount | (% by |
| | Product name | name | added | mass) |
| Surface-treated | TIPAQUE | KF-96L-1cs | 0.5 parts | 92.5 |
| titanium oxide 2 | CR-97 | | | |
| Surface-treated | TIPAQUE | KF-96L-1cs | 0.5 parts | 92.5 |
| titanium oxide 3 | CR-80 | | | |
| Surface-treated | TIPAQUE | KF-96L-1cs | 0.5 parts | 94.5 |
| titanium oxide 4 | CR-50 | | | |
| Surface-treated | TIPAQUE | KF-945 | 0.5 parts | 92.5 |
| titanium oxide 5 | CR-58 | | | |
| Surface-treated | TIPAQUE | KF-96L-1cs | 0.5 parts | 92.5 |
| titanium oxide 6 | R-930 | | | |
| Surface-treated | TIPAQUE | KF-96L-1cs | 0.5 parts | 95.5 |
| titanium oxide 7 | A-220 | | | |

KF-945 in Table 2 is a silicone oil containing a polyether-modified polydimethylsiloxane, manufactured by Shin-Etsu Silicone Co., Ltd.

### (Synthesis Example for Binder Resin 1)

A flask fitted with a reflux condenser, a distillation column, a nitrogen gas inlet, a thermometer and a stirrer was charged with the polyhydric alcohols, the polybasic acids and the catalyst shown below. Following addition of these components, nitrogen gas was introduced into the flask while the contents were stirred, and the contents were then heated to 180° C. and reacted for 3 hours while this reaction system temperature was maintained.

Polyhydric Alcohols

Bisphenol A propylene oxide adduct: 480 parts (a compound of general formula (2) in which R represents a propylene group and x=y=2)

Bisphenol A ethylene oxide adduct: 200 parts (a compound of general formula (2) in which R represents an ethylene group and x=y=2)

Polybasic Acids

Terephthalic acid: 260 parts

Trimellitic acid: 50 parts

Catalyst

Dibutyltin oxide: 2 parts Subsequently, the above mixture was reacted for a further one hour under reduced pressure, and the reaction system was then returned to normal pressure, the temperature of the reaction system was reduced to 100° C. or lower, and the polycondensation was halted, thus obtaining a polyester resin A.

Subsequently, 800 parts of the obtained polyester resin A was added to an equal amount (equal mass) of toluene and dissolved by heating. Following dissolution, the solution was stirred while nitrogen gas was introduced, and following heating to the boiling point of toluene, a mixed solution containing the polymerizable monomers and the polymerization initiator shown below was added dropwise over a period of 2 hours to effect a solution polymerization. Following completion of the dropwise addition, reaction was continued for a further 2 hours at the boiling point temperature of toluene, and 1 part of di-t-butyl peroxide was then added and the polymerization was halted. Subsequently, the reaction mixture was heated to 180° C. to remove the toluene, thus obtaining a binder resin 1 containing a polyester resin and a styrene-acrylic copolymer resin.

Polymerizable Monomers

Styrene: 115 parts

Acrylic acid: 20 parts

2-ethylhexyl acrylate: 62 parts

Polymerization Initiator

Di-t-butyl peroxide: 4 parts

The weight average molecular weight of the binder resin 1 measured by the method described above using a Gel Permeation Chromatograph (HLC-8220) manufactured by Tosoh Corporation was 14,000. Further, the acid value of the binder resin measured by the method described above using an automatic potentiometric titrator AT-610 was 26 mgKOH/g. The SP value of the binder resin calculated using the Fedors method based on formula (1) shown above

### (Synthesis Example for Binder Resin 2)

By performing synthesis in the same manner as the polyester resin A, a binder resin 2 containing a polyester resin was obtained. Measurements using the methods described above revealed that the binder resin 2 had a weight average molecular weight of 7,000, an acid value of 20 mgKOH/g, and an SP value of 11.

### (Synthesis Examples for Binder Resins 3 and 4)

With the exceptions of using the materials and the synthesis conditions shown below in Table 3, binder resins 3 and 4 containing a polyester resin were obtained in the same manner as the binder resin 2.

TABLE 3

| | | Binder | Binder |
|---|---|---|---|
| | | resin 3 | resin 4 |
| Polyhydric | Neopentyl glycol | 730 parts | |
| alcohols | 1,2-propanediol | | 270 parts |
| Polybasic acids | Terephthalic acid | | 420 parts |
| | Fumaric acid | 270 parts | |
| | Trimellitic acid | | 35 parts |
| | Acrylic acid-modified rosin | | 275 parts |
| Reaction temperature before | | 180° C. | 180° C. |
| pressure reduction | | | |
| Reaction time before pressure | | 3 hours | 3 hours |
| reduction | | | |
| Specifications | Weight average molecular | 6000 | 6500 |
| | weight | | |
| | Acid value [mgKOH/g] | 25 | 40 |
| | SP value [(cal/cm³)^{1/2}] | 11 | 12 |

The acrylic acid-modified rosin in the above Table 3 was obtained by charging a flask fitted with a reflux condenser, a distillation column, a thermometer and a stirrer with 225 parts of a purified rosin and 25 parts of acrylic acid, heating the mixture to a temperature of 220° C. over a period of 8 hours, and then holding the temperature of the reaction system for a further 2 hours to complete the reaction, and then distilling the product under reduced pressure.

### (Synthesis Example for Binder Resin 5)

With the exception of altering the reaction temperature before pressure reduction to 150° C., a polyester resin B was obtained in the same manner as the binder resin 4.

Subsequently, 800 parts of the obtained polyester resin B was added to an equal amount (equal mass) of toluene and dissolved by heating. Following dissolution, the solution was stirred while nitrogen gas was introduced, and following heating to the boiling point of toluene, a mixed solution containing the polymerizable monomers and the polymerization initiator shown below was added dropwise over a period of 2 hours to effect a solution polymerization. Following completion of the dropwise addition, reaction was continued for a further 2 hours at the boiling point temperature of toluene, and 1 part of di-t-butyl peroxide was then added and the polymerization was halted. Subsequently, the reaction mixture was heated to 180° C. to remove the toluene, thus obtaining a binder resin 5 containing a polyester resin and a styrene-acrylic copolymer resin.

Polymerizable Monomers

Styrene: 115 parts

Acrylic acid: 20 parts

2-ethylhexyl acrylate: 62 parts

Polymerization Initiator

Di-t-butyl peroxide: 4 parts

The weight average molecular weight of the binder resin 5 was 6,500, the acid value was 21 mgKOH/g, and the SP value was 11.

### (Synthesis of Binder Resins 6 to 15)

With the exceptions of using the materials and the synthesis conditions shown below in Table 4, binder resins 6 to 15 were obtained in the same manner as the binder resin 1.

TABLE 4

| | | | | Binder | | Binder | | Binder | | Binder | | Binder | |
|---|---|---|---|---|---|---|---|---|---|---|---|---|---|
| | | | | resin 6 | | resin 7 | | resin 8 | | resin 9 | | resin 10 | |
| Production of | Materials | Polyhydric | Bisphenol A | 480 | parts | 480 | parts | 480 | parts | 480 | parts | 480 | parts |
| polyester | | alcohols | propylene | | | | | | | | | | |
| resin | | | oxide adduct | | | | | | | | | | |
| | | | Bisphenol A | 200 | parts | 200 | parts | 200 | parts | 200 | parts | 200 | parts |
| | | | ethylene | | | | | | | | | | |
| | | | oxide adduct | | | | | | | | | | |
| | | Polybasic | Terephthalic | 270 | parts | 270 | parts | 270 | parts | 260 | parts | 260 | parts |
| | | acids | acid | | | | | | | | | | |
| | | | Trimellitic | 70 | parts | 70 | parts | 70 | parts | 45 | parts | 80 | parts |
| | | | acid | | | | | | | | | | |
| | Reaction temperature before pressure reduction | | | 200° | C. | 200° | C. | 140° | C. | 180° | C. | 180° | C. |
| | Reaction time before pressure reduction | | | 7 | hours | 5 | hours | 3 | hours | 3 | hours | 3 | hours |
| | Reaction time under reduced pressure | | | 2 | hours | 1 | hours | 1 | hours | 1 | hours | 1 | hours |
| Addition of | Materials | Polymerizable | Styrene | 115 | parts | 115 | parts | 115 | parts | 115 | parts | 115 | parts |
| styrene- | | monomers | Acrylic acid | 20 | parts | 20 | parts | 20 | parts | 20 | parts | 20 | parts |
| acrylic resin | | | 2-ethylhexyl | 62 | parts | 62 | parts | 62 | parts | 62 | parts | 62 | parts |
| | | | acrylate | | | | | | | | | | |
| Specifications | Weight average molecular weight | | | 100000 | | 60000 | | 4000 | | 21000 | | 20000 | |
| | Acid value [mgKOH/g] | | | 20 | | 23 | | 30 | | 15 | | 28 | |
| | SP value [(cal/cm³)^{1/2}] | | | 11 | | 11 | | 11 | | 11 | | 11 | |
| | | | | Binder | | Binder | | Binder | | Binder | | Binder | |
| | | | | resin 11 | | resin 12 | | resin 13 | | resin 14 | | resin 15 | |
| Production of | Materials | Polyhydric | Bisphenol A | 480 | parts | 480 | parts | 680 | parts | 680 | parts | 680 | parts |
| polyester | | alcohols | propylene | | | | | | | | | | |
| resin | | | oxide adduct | | | | | | | | | | |
| | | | Bisphenol A | 200 | parts | 200 | parts | | | | | | |
| | | | ethylene | | | | | | | | | | |
| | | | oxide adduct | | | | | | | | | | |
| | | Polybasic | Terephthalic | 260 | parts | 260 | parts | 270 | parts | 270 | parts | 270 | parts |
| | | acids | acid | | | | | | | | | | |
| | | | Trimellitic | 120 | parts | 150 | parts | 70 | parts | 70 | parts | 70 | parts |
| | | | acid | | | | | | | | | | |
| | Reaction temperature before pressure reduction | | | 180° | C. | 180° | C. | 200° | C. | 200° | C. | 200° | C. |
| | Reaction time before pressure reduction | | | 3 | hours | 3 | hours | 5 | hours | 5 | hours | 5 | hours |
| | Reaction time under reduced pressure | | | 1 | hours | 1 | hours | 1 | hours | 1 | hours | 1 | hours |
| Addition of | Materials | Polymerizable | Styrene | 115 | parts | 115 | parts | 115 | parts | 50 | parts | 20 | parts |
| styrene- | | monomers | Acrylic acid | 20 | parts | 20 | parts | 20 | parts | 95 | parts | 115 | parts |
| acrylic resin | | | 2-ethylhexyl | 62 | parts | 62 | parts | 62 | parts | 62 | parts | 62 | parts |
| | | | acrylate | | | | | | | | | | |

| | | | | | | |
|---|---|---|---|---|---|---|
| Specifications | Weight average molecular weight | 19000 | 18000 | 50000 | 55000 | 50000 |
| | Acid value [mgKOH/g] | 55 | 73 | 24 | 40 | 50 |
| | SP value [(cal/cm³)^{1/2}] | 11 | 11 | 9 | 12 | 14 |

The bisphenol A propylene oxide adduct in Table 4 is a compound of the general formula (2) in which R represents a propylene group, and x=y=2, whereas the bisphenol A ethylene oxide adduct is a compound of the general formula (2) in which R represents an ethylene group and x=y=2.

### (Synthesis of Solution of Basic Polymeric Dispersant 1)

A reaction container fitted with a nitrogen gas inlet, a thermometer, a condenser and a stirrer was charged with 90.1 parts of IP Solvent 2028 (an isoparaffin-based hydrocarbon solvent, manufactured by Idemitsu Kosan Co., Ltd.), and the container was flushed with nitrogen gas. The contents of the reaction container were heated to 110° C., and a mixture containing 20 parts of N,N-dimethylaminoethyl methacrylate, 60 parts of stearyl methacrylate and 20 parts of butyl acrylate as polymerizable monomers, and also containing 9 parts of dimethyl 2,2′-azobis(2-methylpropionate) (V-601, manufactured by Wako Pure Chemical Industries, Ltd.) as a polymerization initiator was added dropwise to the reaction container over a period of 2 hours to effect a polymerization reaction. Following completion of the dropwise addition, reaction was continued at 110° C. for a further 3 hours, an additional 0.9 parts of V-601 was then added, and reaction was continued at 110° C. for a further one hour, thus obtaining a solution of a basic polymeric dispersant 1. The weight average molecular weight of the basic polymeric dispersant 1 was about 7,380, and the amine value measured in accordance with the method prescribed in ASTM D2074 was 65 mgKOH/g. One gram of this mixed solution was sampled and dried by heating at 180° C. for 20 minutes to measure the solid fraction concentration. Based on the thus obtained solid fraction concentration, sufficient IP solvent 2028 was added to the prepared dispersant solution to adjust the non-volatile fraction to 50%, thus obtaining a solution of the basic polymeric dispersant 1 having a solid fraction concentration of 50%.

### (Synthesis of Solution of Basic Polymeric Dispersant 2)

A solution of a basic polymeric dispersant 2 was prepared by dissolving 50 parts of a vinylpyrrolidone-hexadecene copolymer Antaron-V216 manufactured by ISP Japan Ltd. in an equal amount (equal mass) of IP Solvent 2028.

### (Synthesis of Solution of Polymeric Dispersant 3)

With the exception of altering the polymerizable monomers to 20 parts of acrylamide, 60 parts of stearyl methacrylate and 20 parts of butyl acrylate, a solution of a polymeric dispersant 3 with a solid fraction concentration of 50% was obtained using the same method as the basic polymeric dispersant 1. The weight average molecular weight (Mw) of the polymeric dispersant 3 was about 7,010, and the amine value was 0 mgKOH/g.

### Example 1

### (Production of Liquid Developer 1)

TIPAQUE PF-671: 50 parts by mass

Binder resin 1: 50 parts by mass

The above materials (total: 5 kg) were added to a Henschel mixer (capacity: 20 L) and mixed (3,000 rpm, 3 minutes). Subsequently, using a twin-screw kneading extruder (PCM30), the above mixture was subjected to melt kneading under conditions including a supply rate of 6 kg/hr and a discharge temperature of 145° C., and was then further kneaded using a triple roll mill under conditions including a roll temperature of 140° C., thus obtaining a white master batch 1.

Following cooling and solidification of the white master batch 1 obtained above, the solid product was coarsely ground using a hammer mill, and was then finely ground using an I-type jet mill (model: IDS-2), thus obtaining a white ground product W1 having an average particle size of 6.0 μm.

White ground product W1: 25 parts by mass

Solution of the basic polymeric dispersant 1: 3 parts by mass

IP Solvent 2028 (an isoparaffin-based hydrocarbon solvent, manufactured by Idemitsu Kosan Co., Ltd., aniline point: 89° C., dry point: 262° C.): 72 parts by mass

The above materials were weighed, and then stirred and mixed thoroughly to form a slurry (the slurry concentration at this point was 25% by mass). Using a Dyno-Mill Multilab (manufactured by Shinmaru Enterprises Corporation, capacity: 1.4 L), which is a medium stirring mill, the slurry was subjected to wet grinding under circulatory operating conditions. The particle size of the white ground product W1 was measured, and the wet grinding was halted once the average particle size (D50) reached 2.0 μm or less.

Specifics regarding the conditions used during the wet grinding were as follows. Agitator discs (material: zirconia), peripheral speed: 10 m/s, cylinder: ZTA, media (material: zirconia) diameter: 1.25 mm, fill rate: 70% by volume, solution flow rate: 45 kg/h, cooling water: 5 L/min, pressure: 0.1 kg/cm². After performing wet grinding for 60 minutes, the slurry was removed and passed through a mesh (made of SUS304) having a mesh size of 33 μm, thus obtaining a white liquid developer 1W.

The above particle size was measured using a laser diffraction and scattering particle size analyzer Microtrac HRA manufactured by Nikkiso Co., Ltd., under atmospheric conditions of 23° C. and 50% RH, using the method described above. The refractive index of titanium oxide of 2.71 was used as the particle refractive index used in calculating the above D50 value.

### Examples 2 to 36, Comparative Examples 1 to 5

### (Production of White Liquid Developers 2W to 41W)

Using the raw materials shown in Tables 5 and 6, white ground products were produced using the same method as that described for the white ground product W1. Subsequently, using the white ground products, the basic dispersants and the carrier liquids shown in Table 7, white liquid developers were prepared using the same method as that described for the white liquid developer 1W.

TABLE 5

| | | White ground product | | | | | | | | | | | | | | | |
|---|---|---|---|---|---|---|---|---|---|---|---|---|---|---|---|---|---|
| | | W1 | W2 | W3 | W4 | W5 | W6 | W7 | W8 | W9 | W10 | W11 | W12 | W13 | W14 | W15 | W16 |
| Titanium | TIPAQUE PF671 | 50 | | | | | | | | | | | | | | | |
| oxide (A) | TIPAQUE PF690 | | 50 | | | | | | | | | | | | | | |
| | TIPAQUE PF691 | | | 50 | | | | | | | | | | | | | |
| | TIPAQUE PF739 | | | | 50 | | | | | | | | | | | | |
| | TIPAQUE PF740 | | | | | 50 | | | | | | | | | | | |
| | TIPAQUE CR-63 | | | | | | 50 | | | | | | | | | | |
| | TIPAQUE CR-97 | | | | | | | 50 | | | | | | | | | |
| | KRONOS 2230 | | | | | | | | 50 | | | | | | | | |
| | TIPAQUE A-220 | | | | | | | | | 50 | | | | | | | |
| | Surface-treated | | | | | | | | | | 50 | | | | | | |
| | titanium oxide 1 | | | | | | | | | | | | | | | | |
| | Surface-treated | | | | | | | | | | | 50 | | | | | |
| | titanium oxide 2 | | | | | | | | | | | | | | | | |
| | Surface-treated | | | | | | | | | | | | 50 | | | | |
| | titanium oxide 3 | | | | | | | | | | | | | | | | |
| | Surface-treated | | | | | | | | | | | | | 50 | | | |
| | titanium oxide 4 | | | | | | | | | | | | | | | | |
| | Surface-treated | | | | | | | | | | | | | | 50 | | |
| | titanium oxide 5 | | | | | | | | | | | | | | | | |
| | Surface-treated | | | | | | | | | | | | | | | 50 | |
| | titanium oxide 6 | | | | | | | | | | | | | | | | |
| | Surface-treated | | | | | | | | | | | | | | | | 50 |
| | titanium oxide 7 | | | | | | | | | | | | | | | | |
| Binder | Binder resin 1 | 50 | 50 | 50 | 50 | 50 | 50 | 50 | 50 | 50 | 50 | 50 | 50 | 50 | 50 | 50 | 50 |
| resin (B) | | | | | | | | | | | | | | | | | |

Units: parts by mass

TABLE 6

| | | White ground product | | | | | | | | | | |
|---|---|---|---|---|---|---|---|---|---|---|---|---|
| | | W17 | W18 | W19 | W20 | W21 | W22 | W23 | W24 | W25 | W26 | W27 |
| Titanium | TIPAQUE CR-63 | 50 | 50 | 50 | 50 | 50 | 50 | 50 | 50 | 50 | 50 | 50 |
| oxide (A) | Surface-treated | | | | | | | | | | | |
| | titanium oxide 1 | | | | | | | | | | | |
| Binder | HIMER ST-95 | 50 | | | | | | | | | | |
| resin (B) | Binder resin 1 | | | | | | | | | | | |
| | Binder resin 2 | | 50 | | | | | | | | | |
| | Binder resin 3 | | | 50 | | | | | | | | |
| | Binder resin 4 | | | | 50 | | | | | | | |
| | Binder resin 5 | | | | | 50 | | | | | | |
| | Binder resin 6 | | | | | | 50 | | | | | |
| | Binder resin 7 | | | | | | | 50 | | | | |
| | Binder resin 8 | | | | | | | | 50 | | | |
| | Binder resin 9 | | | | | | | | | 50 | | |
| | Binder resin 10 | | | | | | | | | | 50 | |
| | Binder resin 11 | | | | | | | | | | | 50 |
| | Binder resin 12 | | | | | | | | | | | |
| | Binder resin 13 | | | | | | | | | | | |
| | Binder resin 14 | | | | | | | | | | | |
| | Binder resin 15 | | | | | | | | | | | |
| Release | HI-WAX 720P | | | | | | | | | | | |
| agent | Polywax 500 | | | | | | | | | | | |
| | | White ground product | | | | | | | | | | |
| | | W28 | W29 | W30 | W31 | W32 | W33 | W34 | W35 | W36 | W37 | W38 |
| Titanium | TIPAQUE CR-63 | 50 | 50 | 50 | 50 | 50 | 10 | 30 | 70 | 45 | 45 | |
| oxide (A) | Surface-treated | | | | | | | | | | | 45 |
| | titanium oxide 1 | | | | | | | | | | | |
| Binder | HIMER ST-95 | | | | | | | | | | | |
| resin (B) | Binder resin 1 | | | | | | 90 | 70 | 30 | 50 | 50 | 50 |
| | Binder resin 2 | | | | | | | | | | | |
| | Binder resin 3 | | | | | | | | | | | |
| | Binder resin 4 | | | | | | | | | | | |
| | Binder resin 5 | | | | | | | | | | | |
| | Binder resin 6 | | | | | | | | | | | |
| | Binder resin 7 | | | | | | | | | | | |
| | Binder resin 8 | | | | | | | | | | | |
| | Binder resin 9 | | | | | 25 | | | | | | |
| | Binder resin 10 | | | | | | | | | | | |
| | Binder resin 11 | | | | | | | | | | | |
| | Binder resin 12 | 50 | | | | 25 | | | | | | |
| | Binder resin 13 | | 50 | | | | | | | | | |
| | Binder resin 14 | | | 50 | | | | | | | | |
| | Binder resin 15 | | | | 50 | | | | | | | |
| Release | HI-WAX 720P | | | | | | | | | 5 | | |
| agent | Polywax 500 | | | | | | | | | | 5 | 5 |

Units: parts by mass

TABLE 7

| | | | Parts | | Parts | | Parts |
|---|---|---|---|---|---|---|---|
| | | | by | | by | Carrier | by |
| | | White ground product | mass | Dispersant | mass | liquid | mass |
| Example 1 | White liquid developer 1W | White ground product W1 | 25 | Basic | 3 | IP | 72 |
| Example 2 | White liquid developer 2W | White ground product W2 | | polymeric | | solvent | |
| Example 3 | White liquid developer 3W | White ground product W3 | | dispersant 1 | | 2028 | |
| Example 4 | White liquid developer 4W | White ground product W4 | | | | | |
| Example 5 | White liquid developer 5W | White ground product W5 | | | | | |
| Example 6 | White liquid developer 6W | White ground product W6 | | | | | |
| Comparative | White liquid developer 7W | White ground product W7 | | | | | |
| Example 1 | | | | | | | |
| Example 7 | White liquid developer 8W | White ground product W8 | | | | | |
| Comparative | White liquid developer 9W | White ground product W9 | | | | | |
| Example 2 | | | | | | | |
| Example 8 | White liquid developer 10W | White ground product W10 | | | | | |
| Example 9 | White liquid developer 11W | White ground product W11 | | | | | |
| Example 10 | White liquid developer 12W | White ground product W12 | | | | | |
| Example 11 | White liquid developer 13W | White ground product W13 | | | | | |
| Example 12 | White liquid developer 14W | White ground product W14 | | | | | |
| Example 13 | White liquid developer 15W | White ground product W15 | | | | | |
| Example 14 | White liquid developer 16W | White ground product W16 | | | | | |
| Example 15 | White liquid developer 17W | White ground product W17 | | | | | |
| Example 16 | White liquid developer 18W | White ground product W18 | | | | | |
| Example 17 | White liquid developer 19W | White ground product W19 | | | | | |
| Example 18 | White liquid developer 20W | White ground product W20 | | | | | |
| Example 19 | White liquid developer 21W | White ground product W21 | | | | | |
| Example 20 | White liquid developer 22W | White ground product W22 | | | | | |
| Example 21 | White liquid developer 23W | White ground product W23 | | | | | |
| Example 22 | White liquid developer 24W | White ground product W24 | | | | | |
| Example 23 | White liquid developer 25W | White ground product W25 | | | | | |
| Example 24 | White liquid developer 26W | White ground product W26 | | | | | |
| Example 25 | White liquid developer 27W | White ground product W27 | | | | | |
| Example 26 | White liquid developer 28W | White ground product W28 | | | | | |
| Comparative | White liquid developer 29W | White ground product W29 | | | | | |
| Example 3 | | | | | | | |
| Example 27 | White liquid developer 30W | White ground product W30 | | | | | |
| Comparative | White liquid developer 31W | White ground product W31 | | | | | |
| Example 4 | | | | | | | |
| Example 28 | White liquid developer 32W | White ground product W32 | | | | | |
| Example 29 | White liquid developer 33W | White ground product W33 | | | | | |
| Example 30 | White liquid developer 34W | White ground product W34 | | | | | |
| Example 31 | White liquid developer 35W | White ground product W35 | | | | | |
| Example 32 | White liquid developer 36W | White ground product W6 | | Basic | | | |
| | | | | polymeric | | | |
| | | | | dispersant 2 | | | |
| Comparative | White liquid developer 37W | White ground product W6 | | Polymeric | | | |
| Example 5 | | | | dispersant 3 | | | |
| Example 33 | White liquid developer 38W | White ground product W36 | | Basic | | | |
| Example 34 | White liquid developer 39W | White ground product W37 | | polymeric | | | |
| Example 35 | White liquid developer 40W | White ground product W38 | | dispersant 1 | | | |
| Example 36 | White liquid developer 41W | White ground product W5 | | | | Exxsol | |
| | | | | | | D130 | |

Units: parts by mass

In Table 6, HIMER ST-95 represents a polystyrene (Mw: 4,000, acid value: 21 mgKOH/g, SP value: 10) manufactured by Sanyo Chemical Industries, Ltd., HI-WAX 720P represents a polyethylene (Mw: 7,200, melting point: 113° C.) manufactured by Mitsui Chemicals, Inc., and Polywax 500 represents a polyethylene (Mw: 540, melting point: 88° C.) manufactured by Toyo ADL Corporation. Further, in Table 7, Exxsol D130 represents a naphthene-based hydrocarbon (aniline point: 88° C., dry point: 313° C.) manufactured by Exxon Mobil Corporation.

Each of the white liquid developers shown above in Table 7 was subjected to the following evaluations. The evaluation results are shown in Table 8.

### (Actual Copy Test)

Using a modified version of a commercially available liquid developer copier (Savin 870, manufactured by Savin Corporation), 100 copies of white solid printing were printed continuously onto A4 size PET films at a printing speed of 30 m/min and under atmospheric conditions of 23° C. and 50% RH, using an amorphous silicon photoreceptor with the photoreceptor surface potential set to +450 to 500 V, the residual potential set to not more than +50 V, the developing roller bias set to +250 to 450 V, and the thermal fixing temperature set to 120° C. Evaluations of the opacity described below were performed using the 100th image. In each of the evaluations of the primary and secondary transferability, 100 copies of white solid printing were printed separately from the above opacity evaluation under the same conditions as those described above.

### (Opacity Evaluation)

The white solid printed item obtained in the above actual copy test was placed on a paper substrate having a black single-color image with a density (ID value) of 1.80, an X-Rite 504 was used to measure the black image density under conditions including a D50 light source, a viewing angle of 2° and the Status-E condition, and the opacity was evaluated based on the degree of reduction in the black density. The evaluation criteria were as follows, with a D level or better being preferred from a practical perspective.

A: black ID value of less than 0.15

B: black ID value of at least 0.15 but less than 0.2

C: black ID value of at least 0.2 but less than 0.25

D: black ID value of at least 0.25 but less than 0.3

E: black ID value of 0.3 or higher

### (Primary Transferability Evaluation)

When printing the 100th image in the aforementioned actual copy test, printing was temporarily halted in the state where the liquid developer was disposed on the photoreceptor, and the liquid developer layer on the photoreceptor was sampled using a tape and adhered to a PET film. Subsequently, printing was restarted, was halted once again when the liquid developer layer on the photoreceptor had been transferred to the intermediate transfer body, and the liquid developer layer remaining on the photoreceptor was sampled using a tape and adhered to a PET film.

The PET films to which were adhered the liquid developer layer on the photoreceptor that had been sampled before and after transfer of the liquid developer to the intermediate transfer body were each placed on a paper substrate having a black single-color image with a density (ID value) of 1.80, and the same method as that described in the above opacity evaluation was used to measure the image density (ID value) of the black single-color image. Evaluation of the primary transferability was performed by using the black ID values obtained in these measurements to calculate the primary transfer efficiency (TE1 value) from formula (4) shown below. The evaluation criteria were as follows, with a C level or better being preferred from a practical perspective.

A: primary transfer efficiency (TE1 value) of 95% or higher

B: primary transfer efficiency (TE1 value) of at least 93% but less than 95%

C: primary transfer efficiency (TE1 value) of at least 90% but less than 93%

D: primary transfer efficiency (TE1 value) of less than 90%

TE1 value=100×(ID2−ID1)/(1.8−ID1) (4)

In the above formula (4), ID1 represents the black ID value of the PET film to which was adhered the liquid developer layer on the photoreceptor that was sampled before transfer to the intermediate transfer body, whereas ID2 represents the black ID value of the PET film to which was adhered the residual liquid developer layer on the photoreceptor that was sampled after transfer to the intermediate transfer body.

### (Secondary Transferability Evaluation)

When printing the 100th image in the aforementioned actual copy test, printing was temporarily halted in the state where the liquid developer was disposed on the intermediate transfer body, and the liquid developer layer on the intermediate transfer body was sampled using a tape and adhered to a PET film. Subsequently, printing was restarted, was halted once again when the liquid developer layer on the intermediate transfer body had been transferred to the printing substrate (PET film), and the liquid developer layer remaining on the intermediate transfer body was sampled using a tape and adhered to a PET film.

The PET films to which were adhered the liquid developer layer on the intermediate transfer body that had been sampled before and after transfer of the liquid developer to the printing substrate were each placed on a paper substrate having a black single-color image with a density (ID value) of 1.80, and the same method as that described in the above opacity evaluation was used to measure the image density (ID value) of the black single-color image. Evaluation of the secondary transferability was performed by using the black ID values obtained in these measurements to calculate the secondary transfer efficiency (TE2 value) from formula (5) shown below. The evaluation criteria were as follows, with a C level or better being preferred from a practical perspective.

A: secondary transfer efficiency (TE2 value) of 95% or higher

B: secondary transfer efficiency (TE2 value) of at least 93% but less than 95%

C: secondary transfer efficiency (TE2 value) of at least 90% but less than 93%

D: secondary transfer efficiency (TE2 value) of less than 90%

TE2 value=100×(ID4−ID3)/(1.8−ID3) (5)

In the above formula (5), ID3 represents the black ID value of the PET film to which was adhered the liquid developer layer on the intermediate transfer body that was sampled before transfer to the printing substrate, whereas ID4 represents the black ID value of the PET film to which was adhered the residual liquid developer layer on the intermediate transfer body that was sampled after transfer to the printing substrate.

### (Storage Stability Evaluation)

Each of the liquid developers shown above in Table 7 was left to stand for 3 months in a constant-temperature and constant-humidity atmosphere at 25° C. and 50% RH. After standing for 3 months, the average particle size (D50) of the liquid developer was remeasured using the method described above, and the storage stability was evaluated by determining the increase in the measured value from the value prior to starting the test. The evaluation criteria were as follows, with a D level or better being preferred from a practical perspective.

A: Average particle size (D50) after test/average particle size (D50) before test is less than 1.05

B: Average particle size (D50) after test/average particle size (D50) before test is at least 1.05 but less than 1.1

C: Average particle size (D50) after test/average particle size (D50) before test is at least 1.1 but less than 1.15

D: Average particle size (D50) after test/average particle size (D50) before test is at least 1.15 but less than 1.2

E: Average particle size (D50) after test/average particle size (D50) before test is 1.2 or greater

TABLE 8

| | | Evaluation Results | | | |
|---|---|---|---|---|---|
| | | | Primary | Secondary | |
| | | Opacity | transferability | transferability | Storage stability |
| Example 1 | White liquid developer 1W | C | A | B | C |
| Example 2 | White liquid developer 2W | C | B | B | C |
| Example 3 | White liquid developer 3W | C | B | B | C |
| Example 4 | White liquid developer 4W | B | A | A | B |
| Example 5 | White liquid developer 5W | A | A | A | B |
| Example 6 | White liquid developer 6W | B | A | A | C |
| Example 7 | White liquid developer 8W | B | A | A | C |
| Example 8 | White liquid developer 10W | A | A | A | B |
| Example 9 | White liquid developer 11W | B | B | B | B |
| Example 10 | White liquid developer 12W | C | B | B | C |
| Example 11 | White liquid developer 13W | C | B | B | C |
| Example 12 | White liquid developer 14W | C | B | B | C |
| Example 13 | White liquid developer 15W | C | B | B | C |
| Example 14 | White liquid developer 16W | B | A | A | C |
| Example 15 | White liquid developer 17W | C | A | B | C |
| Example 16 | White liquid developer 18W | C | A | B | C |
| Example 17 | White liquid developer 19W | C | A | B | C |
| Example 18 | White liquid developer 20W | C | A | B | C |
| Example 19 | White liquid developer 21W | B | A | A | C |
| Example 20 | White liquid developer 22W | C | A | B | C |
| Example 21 | White liquid developer 23W | B | A | A | C |
| Example 22 | White liquid developer 24W | C | A | B | C |
| Example 23 | White liquid developer 25W | D | B | C | D |
| Example 24 | White liquid developer 26W | B | A | A | C |
| Example 25 | White liquid developer 27W | B | A | B | C |
| Example 26 | White liquid developer 28W | D | C | C | C |
| Example 27 | White liquid developer 30W | B | A | B | C |
| Example 28 | White liquid developer 32W | B | A | B | C |
| Example 29 | White liquid developer 33W | C | A | B | C |
| Example 30 | White liquid developer 34W | B | A | A | C |
| Example 31 | White liquid developer 35W | C | B | B | C |
| Example 32 | White liquid developer 36W | B | A | A | C |
| Example 33 | White liquid developer 38W | B | A | A | B |
| Example 34 | White liquid developer 39W | B | A | A | B |
| Example 35 | White liquid developer 40W | A | A | A | A |
| Example 36 | White liquid developer 41W | A | A | A | B |
| Comparative | White liquid developer 7W | E | C | D | C |
| Example 1 | | | | | |
| Comparative | White liquid developer 9W | E | C | D | E |
| Example 2 | | | | | |
| Comparative | White liquid developer 29W | E | C | D | E |
| Example 3 | | | | | |
| Comparative | White liquid developer 31W | E | C | D | E |
| Example 4 | | | | | |
| Comparative | White liquid developer 37W | E | D | D | E |
| Example 5 | | | | | |

Comparative Examples 1 and 2 represent examples in which a titanium oxide that had not been surface-treated with an organic compound was used, and it is thought that because the dispersibility of the titanium oxide was poor, the evaluation results for the opacity and the secondary transferability were inferior. Comparative Example 3 is an example in which the binder resin had a small SP value of 9, and it is thought that the inferior compatibility between the titanium oxide and the binder resin and the poor dispersibility caused the deterioration in the opacity, the secondary transferability and the storage stability that was observed. In contrast, Comparative Example 4 is an example in which the binder resin had a large SP value of 14, but in a similar manner to Comparative Example 3, the results for the opacity, the secondary transferability and the storage stability were poor. Comparative Example 5 represents an example in which a basic polymeric dispersant was not used, and it is thought that unsatisfactory adsorption to the binder resin (B) caused the deterioration in the opacity, the transferability and the storage stability that was observed.

On the other hand, Examples 1 to 36 represent white liquid developers that contain white toner particles containing at least a titanium oxide (A) that has been surface-treated with alumina and an organic compound, and a binder resin (B), as well as a basic polymeric dispersant (C) and a carrier liquid (D), wherein the SP value of the binder resin (B) is from 10 to 13, and in each of these examples, favorable results were obtained for the opacity, the transferability and the storage stability. Among these examples, those examples that used a white liquid developer in which the acid value of the binder resin (B) was from 20 to 70 mgKOH/g exhibited particularly favorable results for the opacity and the secondary transferability.

Examples 1 to 14 represent systems in which the binder resin (B) was fixed, and variations in the type of the titanium oxide (A) were investigated. Example 8 exhibited superior opacity compared with Example 4. The surface-treated titanium oxide 1 used in Example 8 represents a siloxane-treated product of the TIPAQUE PF739 used in Example 4, and it is thought that the above results are due to improvements in the compatibility and dispersibility of the titanium oxide (A) and the binder resin (B). Similarly, in Example 5, by using a siloxane-treated TIPAQUE PF740, a liquid developer having excellent opacity, transferability and storage stability was able to be obtained, in a similar manner to Example 8. Further, Example 1 exhibited superior primary transferability compared with Example 2. It is thought that this is because the TIPAQUE PF671 used in Example 1 had a higher level of purity than the TIPAQUE PF690 used in Example 2, meaning any deterioration in the charging characteristics and the transferability caused by the surface treatment could be suppressed.

Example 6 and Examples 15 to 28 represent systems in which the titanium oxide (A) was fixed, and variations in the type of the binder resin (B) were investigated. Among these, Examples 6, 19, 21 and 24 exhibited particularly superior results for the opacity and the transferability. Comparing Example 6 with Examples 15 to 19, it is clear that Examples 6 and 19 exhibited particularly favorable results for the opacity. Examples 6 and 19 used a binder resin (B) containing a polyester resin (b-1) and a resin (b-2), and it is thought that the presence of the resin (b-2) was able to improve the charging characteristics of the white liquid developer.

Examples 24 and 25 represent systems in which the systems of Examples 23 and 26 were adjusted so that the acid value of the binder resin (B) was within a range from 20 to 70 mgKOH/g, and the opacity and secondary transferability exhibited particularly superior results. It is thought that an improvement in the compatibility between the titanium oxide (A) and the binder resin (B), and uniform dispersion of the titanium oxide (A) within the white toner particles yielded an improvement in the opacity, and that maintenance of favorable charging characteristics while achieving a reduction in the electric charge attenuation rate resulted in improved transferability. Further, compared with Comparative Examples 3 and 4, Example 27 represents a system in which the SP value of the binder resin (B) was kept within a range from 10 to 13, and it is thought that by improving the compatibility with the titanium oxide (A), and improving the affinity with the basic polymeric dispersant (C), a white liquid developer having excellent opacity, primary transferability and storage stability was able to be obtained.

Examples 33 to 35 are examples that used white toner particles containing at least a titanium oxide (A) that had been surface-treated with alumina and an organic compound, the binder resin (B), and a release agent. Compared with systems that did not contain a release agent, specifically by comparing Examples 33 and 34 with Example 6, or by comparing Example 35 with Example 8, it was evident that superior results were obtained for the storage stability. Although the reasons are not entirely clear, it is thought that by using a polyolefin wax as a release agent, the adsorption of the basic polymeric compound (C) could be improved.

The above results indicated that the white liquid developer of the present invention had excellent opacity, transferability, and dispersion stability within the carrier liquid.

1. A white liquid developer comprising at least white toner particles containing a titanium oxide (A) as a pigment and a binder resin (B), a basic polymeric dispersant (C), and a carrier liquid (D), wherein
the titanium oxide (A) is a titanium oxide that has been surface-treated with alumina and an organic compound, and
the binder resin (B) has a solubility parameter of 10 to 13.

2. The white liquid developer according to claim 1, wherein an acid value of the binder resin (B) is from 20 to 70 mgKOH/g.

3. The white liquid developer according to claim 2, wherein the organic compound comprises at least a siloxane compound.

4. The white liquid developer according to claim 2, wherein purity of the titanium oxide (A) is from 95 to 99% by mass.

5. A method for producing the white liquid developer according to claim 2, the method comprising:
a step of producing chips for white toner particles by melt kneading a mixture comprising the titanium oxide (A) and the binder resin (B), and
a step of mixing the chips for white toner particles with the basic polymeric dispersant (C) and the carrier liquid (D), and performing wet grinding.

6. A printed item comprising a recording medium, and
a layer formed on the recording medium using the white liquid developer according to claim 2.

7. The printed item according to claim 6, wherein the recording medium is at least one medium selected from the group consisting of paper substrates and film substrates.
